(19) United States
(12) Patent Application Publication
(10) Pub. No.: US 2024/0021964 A1
(43) Pub. Date: Jan. 18, 2024

(54) BATTERY AND ELECTRODE TERMINAL

(71) Applicant: Prime Planet Energy & Solutions, Inc., Tokyo (JP)

(72) Inventors: Takafumi TSUJIGUCHI, Himeji-shi (JP); Hitoshi MAEDA, Himeji-shi (JP)

(21) Appl. No.: 18/349,173

(22) Filed: Jul. 10, 2023

(30) Foreign Application Priority Data
Jul. 12, 2022 (JP) 2022-111552

(51) Int. Cl. H01M 50/553; H01M 50/188; H01M 50/184; H01M 50/15

(52) U.S. Cl. CPC H01M 50/553; H01M 50/188; H01M 50/184; H01M 50/15

(57) ABSTRACT

A battery disclosed here includes: an electrode body; a battery case; a sealing plate; an electrode terminal having one end electrically connected to the electrode body inside the battery case and another end inserted in a terminal mounting hole and exposed to outside of the sealing plate; and a resin insulating member. The electrode terminal includes an externally connecting portion located outside the battery case and disposed at the outer surface of the sealing plate, an electrode body connecting portion, and a shaft portion inserted in the terminal mounting hole. The sealing plate has a rectangular shape in plan view, the externally connecting portion includes a body that is flat and rectangular in plan view, and a side surface of the body includes a tapered portion having a tapered shape or a round portion located at each end of the side surface and having a curved shape.

### CROSS REFERENCE TO RELATED APPLICATIONS

This application claims the benefit of priority to Japanese Patent No. 2022-111552 filed on Jul. 12, 2022. The entire contents of this application are hereby incorporated herein by reference.

### BACKGROUND

The present disclosure relates to a battery.

Batteries such as lithium ion secondary batteries are suitably used for portable power supplies for devices such as personal computers and portable terminals, and vehicle driving power supplies for vehicles such as battery electric vehicles (BEVs), hybrid electric vehicles (HEVs), and plug-in hybrid electric vehicles (PHEVs). Such a battery includes, for example, an electrode body including a positive electrode and a negative electrode, a battery case having an opening and housing the electrode body, a sealing plate having a terminal mounting hole and sealing the opening, an electrode terminal having one end connected to the electrode body inside the battery case and another end inserted in the terminal mounting hole and extended out of the sealing plate, and a resin insulating member insulating an outer surface of the sealing plate and the electrode terminal from each other. Examples of techniques related to such a battery include JP2008-251474A and JP2021-086813A.

### SUMMARY

A result of study by inventors of the present disclosure shows that a portion where a metal electrode terminal and a resin insulating member are in contact needs to be designed to have a flat portion in order to seal the electrode terminal and the insulating member more hermetically. On the other hand, it was found that a corner portion at an intersection of flat portions is not easily filled with the insulating member and a gap is formed, resulting in possibility of decrease in hermeticity. If the electrode terminal and the insulating member are not hermetically sealed, a short circuit or the like can occur, and thus, there is still room for improvement in terms of safety of the battery.

It is therefore a main object of the present disclosure to provide a battery with suitably enhanced safety. It is another object to provide an electrode terminal that suitably enhances safety of a battery.

A battery disclosed here includes: an electrode body including a positive electrode and a negative electrode; a battery case having an opening and housing the electrode body; a sealing plate having a terminal mounting hole and sealing the opening; an electrode terminal having one end electrically connected to the electrode body inside the battery case and another end inserted in the terminal mounting hole and exposed to outside of the sealing plate; and a resin insulating member insulating an outer surface of the sealing plate from the electrode terminal, the outer surface being a surface of the sealing plate and located at an outer side of the battery case in a state where the opening is sealed. The electrode terminal includes an externally connecting portion located outside the battery case and disposed at the outer surface of the sealing plate, an electrode body connecting portion electrically connected to the electrode body, and a shaft portion located between the externally connecting portion and the electrode body connecting portion and inserted in the terminal mounting hole. The sealing plate has a rectangular shape in a plan view, the externally connecting portion includes a body that is flat and rectangular in the plan view, and a side surface of the body includes a tapered portion having a tapered shape or a round portion located at each end of the side surface and having a curved shape.

With this configuration, the externally connecting portion includes the body that is flat in plan view so that adhesion between the electrode terminal and the insulating member can be thereby enhanced. Since the externally connecting portion includes the tapered portion and/or the round portions, a periphery of the electrode terminal is suitably filled with the insulating member so that air tightness is thereby enhanced. Accordingly, the sealing plate, the electrode terminal, and the insulating resin are hermetically sealed, and a battery with high safety is achieved.

### BRIEF DESCRIPTION OF THE DRAWINGS

FIG. 1 is a partial cross-sectional view schematically illustrating a battery according to one preferred embodiment.

FIG. 2 is a disassembled perspective view of FIG. 1.

FIG. 3 is a schematic plan view of a sealing plate illustrated in FIG. 1.

FIG. 4 is a schematic longitudinal cross-sectional view taken along line IV-IV in

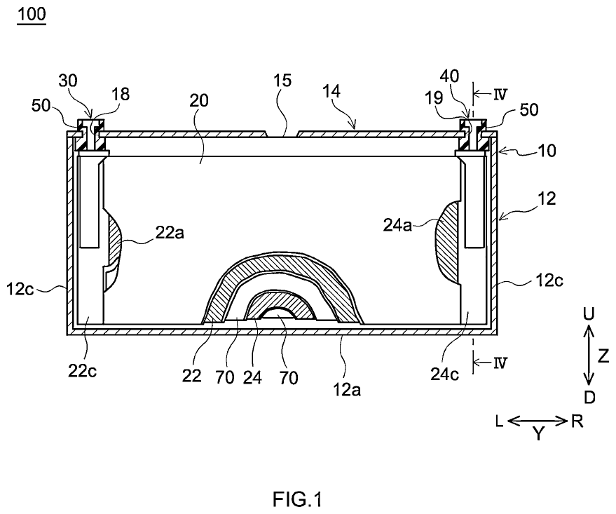

FIG. 1.

FIG. 5 is a plan view illustrating a vicinity of a negative electrode terminal.

FIG. 6 is a plan view illustrating a vicinity of a negative electrode terminal of another example.

FIG. 7 is a plan view illustrating a vicinity of a negative electrode terminal of another example.

FIG. 8 is a schematic view of a molding die according to one preferred embodiment.

### DETAILED DESCRIPTION

A preferred embodiment of the technique disclosed here will be described hereinafter with reference to the drawings. Matters not specifically mentioned herein but required for carrying out the technique disclosed here (e.g., a general configuration and a general fabrication process of a battery that do not characterize the technique disclosed here) can be understood as design matter of those skilled in the art based on related art in the field. The technique disclosed here can be carried out based on the contents disclosed herein and common general knowledge in the field. Members and parts having the same functions are denoted by the same reference characters, and description for the same members and parts will not be repeated or will be simplified as appropriate. The expression “A to B (where A and B are any values)” indicating a range herein means A or more and B or less.

A “battery” herein is a general term for a power storage device capable of extracting electrical energy therefrom, and is a concept including primary batteries and secondary batteries. A “secondary battery” herein is a general term for a power storage device capable of being repeatedly charged and discharged by movement of charge carriers between a positive electrode and a negative electrode through an electrolyte, and is a concept including so-called storage batteries (chemical batteries) such as a lithium ion secondary battery and a nickel-metal hydride battery, and capacitors (physical batteries) such as an electric double layer capacitor.

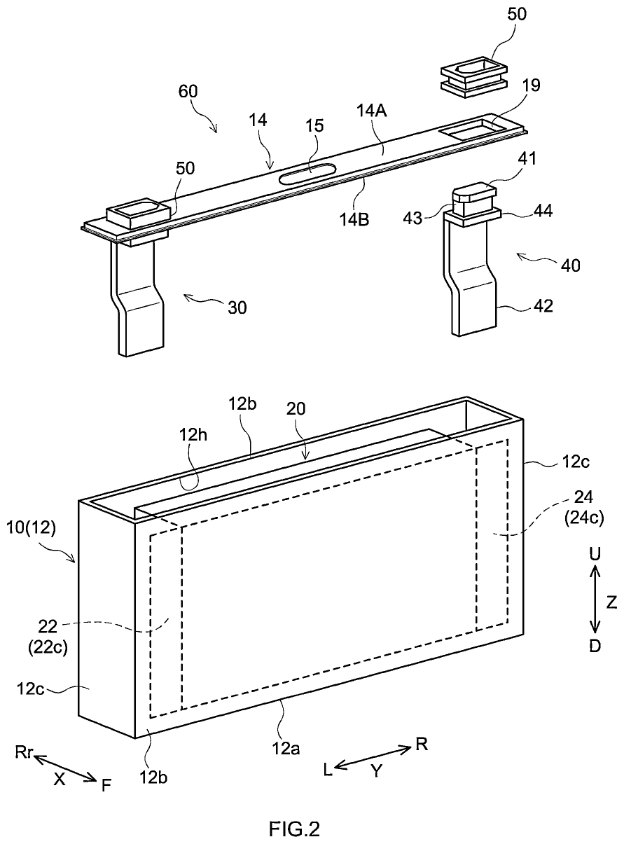

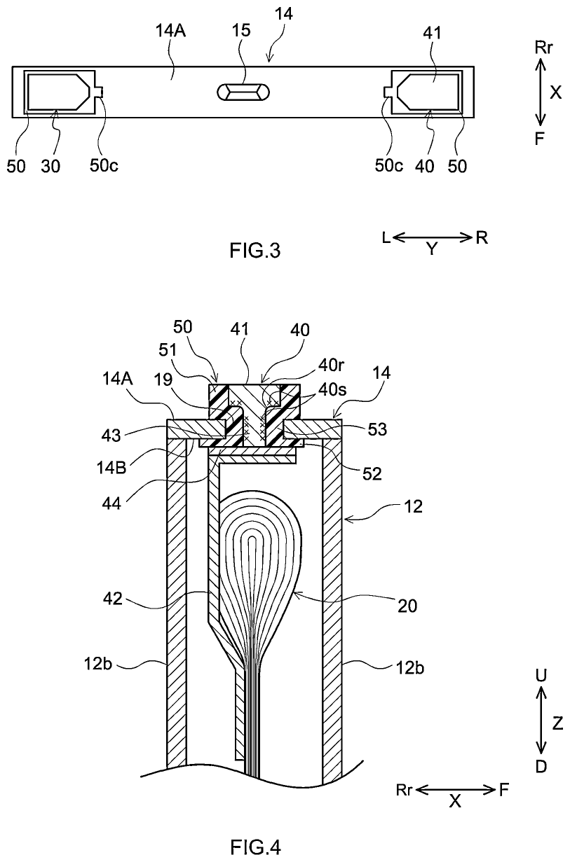

FIG. 1 is a partial cross-sectional view of a battery 100. FIG. 2 is a schematic disassembled perspective view of the battery 100. FIG. 3 is a schematic plan view of a sealing plate 14. In the following description, characters L, R, F, Rr, U, and D in the drawings represent left, right, front, rear, up, and down, respectively. Character X in the drawings represents a “short-side direction of a battery,” character Y represents a “long-side direction of the battery,” and character Z represents a “height direction of the battery.” It should be noted that these directions are defined merely for convenience of description, and do not limit the state of installation of the battery 100.

As illustrated in FIG. 1, the battery 100 includes a battery case 10, an electrode body 20, a positive electrode terminal 30, a negative electrode terminal 40, and an insulating member 50. The positive electrode terminal 30 and/or the negative electrode terminal 40 is an example of an electrode terminal. Although not shown, the battery 100 herein further includes an electrolyte. The battery 100 is preferably a secondary battery, and is more preferably a nonaqueous electrolyte secondary battery such as a lithium ion secondary battery.

The battery case 10 includes a package 12 and the sealing plate 14. The package 12 and the sealing plate 14 are examples of a case member constituting the battery case 10. The battery case 10 herein has a flat rectangular parallelepiped (square) outer shape. In the battery case 10, the sealing plate 14 is joined (e.g., welded) to a periphery of an opening 12h (see FIG. 2) of the package 12 to be thereby integrated with the package 12, for example. Each of the package 12 and the sealing plate 14 is made of, for example, aluminium or an aluminium alloy.

The package 12 is a casing housing an electrode body 20 and an electrolyte. The package 12 is a square container with a bottom, and an upper surface of the package 12 has the opening 12h. The opening 12h is substantially rectangular. As illustrated in FIG. 2, the package 12 includes a bottom wall 12a, a pair of opposed longer walls 12b extending from the bottom wall 12a, and a pair of opposed shorter walls 12c extending from the bottom wall 12a. The bottom wall 12a is substantially rectangular. The bottom wall 12a is opposed to the opening 12h.

The sealing plate 14 is a plate-shaped member that seals the opening 12h of the package 12. As illustrated in FIG. 3, the sealing plate 14 is substantially rectangular in plan view. A size of the sealing plate can be appropriately change depending on, for example, a desired battery capacity, and thus, is not limited to a specific size. As an example, a length of the sealing plate 14 in the short-side direction X may be about 20 mm or more and 30 mm or less, and a length of the sealing plate 14 in the long-side direction Y may be about 140 mm or more and 150 mm or less. The sealing plate 14 is opposed to the bottom wall 12a of the package 12. As illustrated in FIG. 2, the sealing plate 14 has an outer surface 14A facing the outside and located at an outer side of the battery case 10 in a state where the opening 12h is sealed, and an inner surface 14B facing the inside of the battery 100 and opposed to the electrode body 20. The sealing plate 14 has terminal mounting holes 18 and 19 penetrating the outer surface 14A and the inner surface 14B (see FIG. 1). The terminal mounting holes 18 and 19 are located at both ends of the sealing plate 14 in the long-side direction Y. In this preferred embodiment, the terminal mounting hole 18 is associated with the positive electrode terminal 30, and the terminal mounting hole 19 is associated with the negative electrode terminal 40. The sealing plate 14 has a gas release valve 15 and an injection hole (not shown) for injecting the electrolyte. The gas release valve 15 is a thin portion configured such that when a pressure in the battery case 10 increases to a predetermined value or more, the gas release valve 15 is broken and releases a gas in the battery case 10 to the outside.

The battery case 10 can house the electrolyte together with the electrode body 20 as described above. As the electrolyte, a known electrolyte conventionally used for a battery can be used without any particular limitation. As an example, a nonaqueous electrolyte in which a supporting electrolyte is dissolved in a nonaqueous solvent can be used. Examples of the nonaqueous solvent include carbonate-based solvents such as ethylene carbonate, dimethyl carbonate, and ethyl methyl carbonate. Examples of the supporting electrolyte include fluorine-containing lithium salts such as LiPF₆.

As illustrated in FIG. 1, the electrode body 20 is housed inside the package 12. The electrode body 20 is housed inside the package 12 while being covered with, for example, an unillustrated insulating film. The electrode body 20 herein is a wound electrode body in which a strip-shaped positive electrode sheet 22 and a strip-shaped negative electrode sheet 24 are stacked and insulated from each other with two strip-shaped separator sheets 70 interposed therebetween and are wound around a winding axis in the long-side direction. The electrode body 20 may be a laminated electrode body in which rectangular positive electrode sheets and rectangular negative electrode sheets are alternately laminated with rectangular separator sheets interposed therebetween. Alternatively, the electrode body 20 may be a zigzag laminated electrode body configured by sandwiching a plurality of positive electrode sheets and a plurality of negative electrode sheets in a separator sheet folded in a zigzag-manner.

The positive electrode sheet 22 includes a strip-shaped positive electrode current collector 22c, and a positive electrode active material layer 22a fixed onto at least a surface of the positive electrode current collector 22c. As members constituting the positive electrode sheet 22, known materials that can be used for a general battery (e.g., lithium ion secondary battery) can be used without any particular limitation. For example, the positive electrode current collector 22c is preferably made of a conductive metal such as aluminium, an aluminium alloy, nickel, or stainless steel. The positive electrode active material layer 22a includes a positive electrode active material that can reversibly absorb and desorb charge carriers (e.g., a lithium transition metal composite oxide such as lithium-nickel-cobalt-manganese composite oxide). The positive electrode active material layer 22a may include components other than the positive electrode active material, such as a conductive material, a binder, and additives.

The negative electrode sheet 24 includes a strip-shaped negative electrode current collector 24c and a negative electrode active material layer 24a fixed onto at least a surface of the negative electrode current collector 24c. As members constituting the negative electrode sheet 24, known materials that can be used for a general battery (e.g., lithium ion secondary battery) can be used without any particular limitation. For example, the negative electrode current collector 24c is preferably made of a conductive metal such as copper, a copper alloy, nickel, or stainless steel. The negative electrode active material layer 24a includes a negative electrode active material that can reversibly absorb and desorb charge carriers (e.g., a carbon material such as graphite). The negative electrode active material layer 24a may include components other than the negative electrode active material, such as a conductive material, a binder, a disperser, and additives.

Each of the separator sheets 70 is an insulating sheet having a plurality of through holes through which charge carriers can pass. Each separator sheet 70 is made of, for example, a porous resin base material. Examples of the resin base material include sheets (films) of resins, such as polyolefin including polyethylene (PE) and polypropylene (PP), polyester, polyamide, and cellulose. Each separator sheet 70 may have a single-layer structure or a structure in which two or more types of porous resin sheets having different properties and shapes (e.g., thickness and porosity) are laminated (e.g., a three-layer structure in which PP layers are stacked on both surfaces of a PE layer). A surface of each separator sheet 70 may be provided with a heat resistant layer (HRL layer) constituted by, for example, ceramic particles.

As illustrated in FIG. 1, the electrode body 20 housed inside the package 12 is disposed such that one end of the positive electrode current collector 22c is located near a left end of the battery 100 in the long-side direction Y, and one end of the negative electrode current collector 24c is located near a right end of the battery 100 in the long-side direction Y. The positive electrode terminal 30 is attached to one end (left end in FIG. 1) of the sealing plate 14 in the long-side direction Y. The negative electrode terminal 40 is attached to the other end (right end in FIG. 1) of the sealing plate 14 in the long-side direction Y. In the battery 100, the positive electrode terminal 30 and the negative electrode terminal 40 are electrically connected to the electrode body 20 at one end inside the battery case 10 as described above, and are inserted in the terminal mounting holes 18 and 19 at the other end to be exposed to the outside of the sealing plate 14. The positive electrode terminal 30 is preferably made of a highly conductive metal, such as aluminium or an aluminium alloy. The electrode terminal 40 is preferably made of a highly conductive metal, such as copper or a copper alloy.

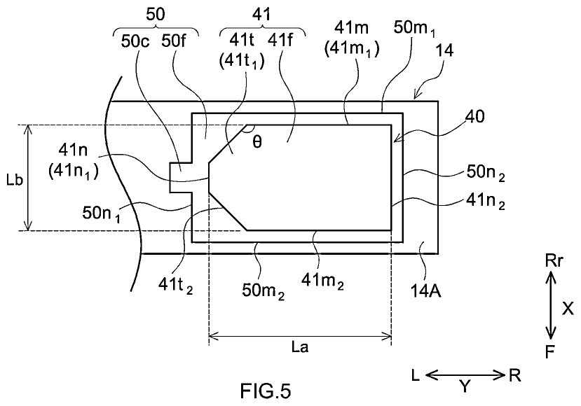

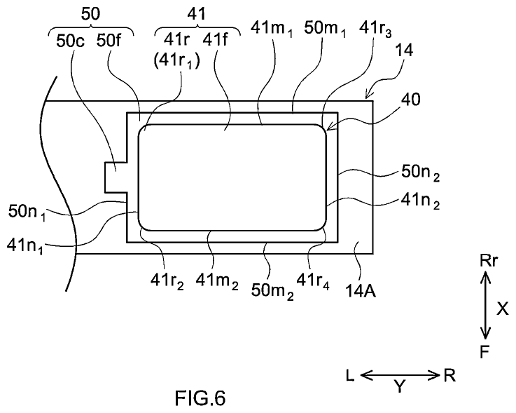

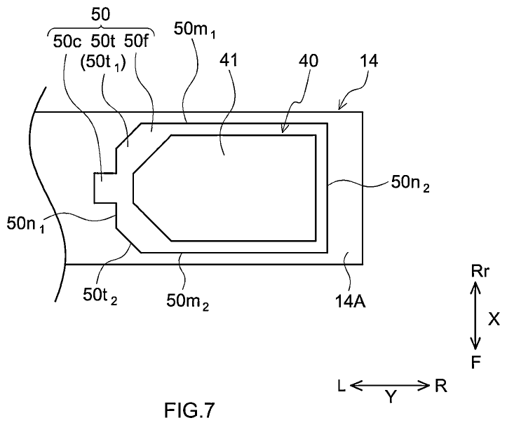

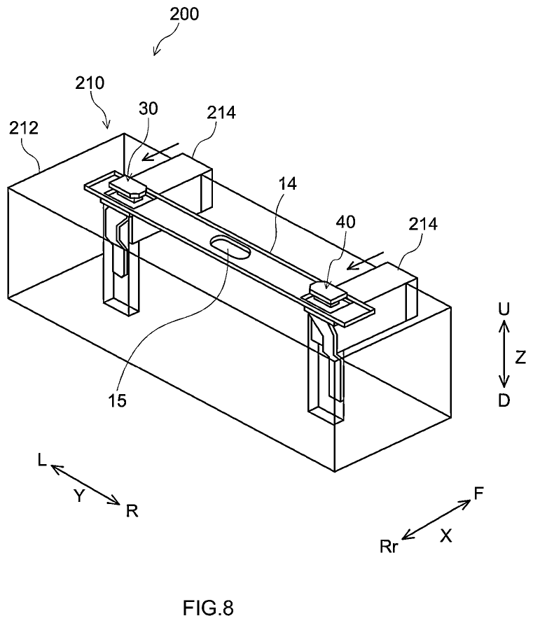

FIG. 4 is a schematic longitudinal cross-sectional view taken along line IV-IV in FIG. 1. As illustrated in FIGS. 2 and 4, the negative electrode terminal 40 includes an externally connecting portion 41, an electrode body connecting portion 42, and a shaft portion 43. The negative electrode terminal 40 herein further includes a support portion 44 between the electrode body connecting portion 42 and the shaft portion 43. In the following description, the negative electrode terminal 40 is an example of an electrode terminal, and the insulating member 50 at the negative electrode terminal 40 is an example of an insulating member. However, this description is not intended to limit an application target of the technique disclosed here to a structure at the negative electrode terminal. That is, the technique disclosed here encompasses an aspect including a positive electrode terminal having a substantially equivalent structure to that of the negative electrode terminal 40 described later.

The insulating member 50 is disposed between the sealing plate 14 and the positive and negative electrode terminals 30 and 40, and prevents electrification between the sealing plate 14 and the positive and negative electrode terminals 30 and 40. The insulating member 50 is made of a resin material. Examples of the resin material include fluorinated resins such as perfluoro-alkoxy fluororesin (PFA), polyphenylene sulfide (PPS) resin, and aliphatic polyamide. The insulating member 50 may be supplemented with an inorganic filler as well as the resin material such as PPS described above.

As illustrated in FIG. 4, the insulating member 50 includes a first flange portion 51, a second flange portion 52, and a cylindrical portion 53. The first flange portion 51, the second flange portion 52, and the cylindrical portion 53 are integrally formed. The first flange portion 51 extends horizontally along the outer surface 14A of the sealing plate 14. The first flange portion 51 insulates the outer surface 14A of the sealing plate 14 from the externally connecting portion 41. The second flange portion 52 extends horizontally along the inner surface 14B of the sealing plate 14. The second flange portion 52 insulates the inner surface 14B of the sealing plate 14 from the support portion 44. The cylindrical portion 53 is located between the first flange portion 51 and the second flange portion 52, and between the terminal mounting hole 19 and the shaft portion 43 of the electrode terminal. The cylindrical portion 53 insulates the terminal mounting hole 19 of the plate 14 from the shaft portion 43 of the electrode terminal. A length of each of the first flange portion 51 and the second flange portion 52 in the short-side direction X is longer than a length of each of the externally connecting portion 41 and the support portion 44 in the short-side direction X. Although not shown, with respect to the long-side direction Y, a length of each of the first flange portion 51 and the second flange portion 52 is also longer than a length of each of the externally connecting portion 41 and the support portion 44 in the long-side direction Y. As illustrated in FIG. 3, in plan view, the first flange portion 51 extends out of the positive electrode terminal 30 and the negative electrode terminal 40 and is exposed to the outside. The shape of the insulating member 50 in plan view, for example, will be described later.

FIGS. 5 through 7 are plan views illustrating a structure near the negative electrode terminal 40 in FIG. 3. The externally connecting portion 41 of the electrode terminal of the battery 100 disclosed herein includes a body 41f having a flat rectangular shape in plan view, and either a tapered portion 41t tapered at one side surface of the body 41f or round parts (R parts) 41r at both ends of the body 41f and each having a predetermined R shape. Since the externally connecting portion 41 has the flat body 41f in plan view, the metal electrode terminal and the resin insulating member 50 adhere to each other more tightly, and are, thereby, more easily hermetically sealed. In addition, since the externally connecting portion 41 has the tapered portion 41t and/or the round parts 41r in plan view, a periphery of the electrode terminal can be appropriately filled with the insulating member 50. Accordingly, the battery 100 with enhanced safety can be achieved.

As shown in FIG. 2, the battery 100 includes an assembly part (sealing plate assembly 60) in which the sealing plate 14, the electrode terminals (the positive electrode terminal and the negative electrode terminal 40) and the insulating member 50 are integrally molded (hereinafter referred to as “insert molding”). In FIG. 2, the sealing plate assembly 60 is shown as a separate part from other parts. In addition, in FIG. 2, regarding the negative electrode terminal the sealing plate 14, the negative electrode terminal 40, and the insulating member 50 are shown as separate parts. As illustrated in FIG. 2, in the battery 100, the sealing plate 14, the electrode terminals (the positive electrode terminal 30 and the negative electrode terminal 40), and the insulating member 50 are preferably insert molded. With this configuration, the sealing plate assembly 60 can be easily detached, which is preferable from the viewpoint of workability.

In the battery 100, in the case of using the sealing plate assembly 60 in which the sealing plate 14, the electrode terminals, and the insulating member 50 are insert molded as described above, the externally connecting portion 41 more suitably exhibits advantages of including the body 41f, and the tapered portion 41t and/or the round portions 41r in plan view. In insert molding, a highly viscous resin is melted and press-injected with the electrode terminals and the sealing plate 14 are combined to thereby form the sealing plate assembly 60, which will be described in detail below. At this time, since the externally connecting portions 41 of the electrode terminals have flat bodies 41f, adhesion between the electrode terminals and the resin (insulating member 50) increases. In addition, since the externally connecting portions 41 include the tapered portions 41t and/or the round portions 41r, even a highly viscous resin can be suitably caused to flow. Accordingly, the electrode terminals and the insulating member 50 are more hermetically sealed with no gaps, thereby enhancing safety of the battery 100.

As illustrated in FIG. 3, the externally connecting portion 41 is located outside the battery case 10 and at the outer surface 14A of the sealing plate 14. The externally connecting portion 41 is typically a plate-shaped conductive member, and extends along the long-side direction Y of the sealing plate 14. The externally connecting portion 41 is exposed at the outer surface 14A of the sealing plate 14. As illustrated in FIG. 4, a length of the externally connecting portion 41 in the short-side direction X is shorter than a length of each of the support portion 44 and the terminal mounting hole 19 in the short-side direction X, and longer than a length of the shaft portion 43 in the short-side direction X. Although not shown, a length of the externally connecting portion 41 in the long-side direction Y is shorter than a length of each of the support portion 44 and the terminal mounting hole 19 in the long-side direction Y, and longer than a length of the shaft portion 43 in the long-side direction Y. That is, a size of the externally connecting portion 41 is adjusted such that the externally connecting portion 41 can be inserted in the terminal mounting hole 19. Accordingly, insert molding described later can be suitably performed. The size of the externally connecting portion 41 can be suitably changed depending on, for example, a desired battery capacity, and thus, is not specifically limited. As an example, a length La of the externally connecting portion 41 in the long-side direction Y (see FIG. 5) may be about 25 mm or more and about 30 mm or less, and a length Lb of the externally connecting portion 41 in the short-side direction X (see FIG. 5) may be about 15 mm or more and about 17 mm or less.

As illustrated in FIGS. 5 and 6, the body 41f constitutes a flat portion extending substantially in parallel with each side of the sealing plate 14 in a plan view of the externally connecting portion 41. Since the externally connecting portion 41 includes the body 41f, adhesion between the electrode terminals and the insulating member 50 made of different materials can be increased. As illustrated in FIGS. 5 and 6, the externally connecting portion 41 includes two first side surfaces 41m₁ and 41m₂ extending along long sides of the sealing plate 14, and two second side surfaces 41n₁ and 41n₂ extending along short sides of the sealing plate 14. In this preferred embodiment, a length of each of the first side surfaces 41m₁ and 41m₂ is longer than a length of each of the second side surfaces 41n₁ and 41n₂. Each of the first side surfaces 41m₁ and 41m₂ and the second side surfaces 41n₁ and 41n₂ constitutes a part of an outer periphery of the externally connecting portion 41 in plan view. The first side surfaces 41m₁ and 41m₂ may have the same length or different lengths. The second side surfaces 41n₁ and 41n₂ may have the same length or different lengths.

The tapered portion 41t constitutes a tilt portion formed in on side surface of the body 41f in a plan view of the externally connecting portion 41. As illustrated in FIG. 5, the externally connecting portion 41 herein includes a first tapered portion 41t₁ and a second tapered portion 41t₂ in the second side surface 41n₁. The first tapered portion 41t₁ is a tilt portion that tilts such that a length in the short-side direction of the first tapered portion 41t₁ continuously decreases from the first side surface 41m₁ toward the second side surface 41n₁. The second tapered portion 41t₂ is a tilt portion that tilts such that a length in the short-side direction of the second tapered portion 41t₂ continuously decreases from the first side surface 41m₂ toward the second side surface 41n₁. Since the externally connecting portion 41 includes the tapered portion 41t in plan view, the resin can be suitably caused to flow. This tapered portion 41t can be formed by, for example, press work.

Although not particularly limited, the tapered portion 41t tilts toward the side surface 41n such that an angle θ formed by the tapered portion 41t and the first side surface 41m is 100° or more. For example, as illustrated in FIG. 5, the first tapered portion 41t₁ preferably tilts toward the second side surface 41n₁ such that an angle θ formed by the first tapered portion 41t₁ and the first side surface 41m₁ is 100° or more and 150° or less. Since the tapered portion 41t has a tilt angle in this range, the resin is more suitably caused to flow.

It is sufficient that the externally connecting portion 41 includes the body 41f having a flat shape in plan view and the tapered portion 41t at one side surface of the body 41f. The externally connecting portion 41 may include two tapered portions (the first tapered portion 41t₁ and the second tapered portion 41t₂) at one side surface or may include one of the first tapered portion 41t₁ and the second tapered portion 41t₂ at one side surface. The externally connecting portion 41 may also include tapered portions 41t at two side surfaces (i.e., at both ends in the short-side direction X) of the body 41f. For example, the externally connecting portion 41 may include a third tapered portion (not shown) that tilts from the first side surface 41m₁ toward the second side surface 41n₂. The externally connecting portion 41 may also include a fourth tapered portion (not shown) that tilts from the first side surface 41m₂ toward the second side surface 41n₂. In the case of forming a plurality of tapered portions 41t, these tapered portions 41t may have the same size or different sizes. That is, the tapered portions 41t may have the same tilt angle or different tilt angles. Preferably, the tapered portions 41t have the same tilt angle. This eases processing of the electrode terminals.

As illustrated in FIG. 6, the round portions 41r constitute curved portions located at both ends of one side surface and curved in predetermined shapes in a plan view of the externally connecting portion 41. The round portions 41r are continuous with the body 41f. As illustrated in FIG. 6, in this preferred embodiment, the externally connecting portion 41 includes a first round portion (R portion) 41r₁, a second round portion (R portion) 41r₂, a third round portion (R portion) 41r₃, and a fourth round portion (R portion)s 41r₄. The first round portion 41r₁ is a curved portion located between the first side surface 41m₁ and the second side surface 41n₁. Similarly, the second round portion 41r₂ is a curved portion located between the first side surface 41m₂ and the second side surface 41n₁, the third round portion 41r₃ is a curved portion located between the first side surface 41m₁ and the second side surface 41n₂, and the fourth round portion 41r₄ is a curved portion located between the first side surface 41m₂ and the second side surface 41n₂. It is sufficient that the round portions 41r are curved such that the corners of the body 41f are rounded. Although not particularly limited, each round portion 41r preferably has a curvature radius of about R1 or more and R5 or less, for example. Since the externally connecting portion 41 has the round portions 41r as described above in plan view, the resin can be suitably caused to flow, and a gap between the externally connecting portion 41 and the insulating member 50 can be suitably reduced. These round portions 41r can be formed by, for example, press work.

It is sufficient for the externally connecting portion 41 to have the round portions 41r at both ends of one side surface of the body 41f. As illustrated in FIG. 6, for example, the externally connecting portion 41 may include the round portions 41r at two side surfaces (i.e., at both ends in the short-side direction X) of the body 41f. In the case of forming a plurality of round portions 41r, these round portions 41r may have the same size or different sizes. That is, the plurality of round portions 41r may have the same curvature radius or different curvature radii. Preferably, the round portions 41r have the same curvature radius. In this case, processing of the electrode terminals.

The externally connecting portion 41 may include the tapered portion 41t at one side surface of the body 41f and include the round portions 41r at both ends of another side surface.

As illustrated in FIGS. 5 and 6, the insulating member 50 includes a body region 50f having a rectangular shape in plan view, and a projection 50c projecting from one side surface of the body region 50f. As illustrated in FIGS. 5 and 6, the insulating member 50 includes two first side surfaces 50m₁ and 50m₂ extending along long sides of the sealing plate 14, and two second side surfaces 50n₁ and 50n₂ extending along short sides of the sealing plate 14. In this preferred embodiment, a length of each of the first side surfaces 50m₁ and 50m₂ is longer than a length of each of the second side surfaces 50n₁ and 50n₂. The first side surfaces 50m₁ and 50m₂ may have the same length or different lengths. The second side surfaces 50n₁ and 50n₂ may have the same length or different lengths.

The projection 50c can be formed in press-injecting a resin melted in an insert molding process described later. The projection 50c is a region projecting from one side surface of the body region 50f. As illustrated in FIGS. 5 and 6, the projection 50c projects from the second side surface 50n₁ leftward in the long-side direction Y. As illustrated in FIG. 3, in this preferred embodiment, the projection 50c projects toward the center of the sealing plate 14 in the long-side direction Y, together with the positive electrode terminal 30 and the negative electrode terminal 40. The projection 50c may project toward an end of the sealing plate 14 in the long-side direction Y or may project to any side in the short-side direction X, for example. The projection 50c may be disposed at different positions between the insulating member 50 at the positive electrode terminal 30 and the insulating member 50 at the negative electrode terminal 40. The projection may have a rectangular shape or a shape having a curve (e.g., a semicircular shape) in plan view.

In an aspect including the projection 50c, the externally connecting portion 41 preferably includes the tapered portion 41t and/or the round portions 41r located near at least the projection 50c. Accordingly, even in the case of press-injecting a highly viscous resin from the projection 50c in the insert molding process, the resin can be suitably caused to flow and a periphery of the externally connecting portion 41 can be suitably filled with the resin. As a result, the battery 100 with higher safety can be provided.

As illustrated in FIG. 7, the insulating member 50 preferably includes the body region 50f, the projection 50c, and a tilt region 50t that tilts from the body region 50f toward the projection 50c. The tilt region 50t constitutes a tilt portion that tilts from the body region 50f toward the projection 50c in a plan view of the insulating member 50. As illustrated in FIG. 7, in this preferred embodiment, the insulating member 50 includes a first tilt region 50t₁ and a second tilt region 50t₂. The first tilt region 50t₁ is a tilt portion that tilts such that a length of the first tilt region 50t₁ in the short-side direction X continuously decreases from the first side surface 50m₁ toward the projection 50c. The second tilt region 50t₂ is a tilt portion that tilts such that a length of the second tilt region 50t₂ in the short-side direction X continuously decreases from the first side surface 50m₂ toward the projection 50c. Since the insulating member 50 includes the tilt region 50t in plan view, the resin can be suitably caused to flow. A tilt angle of the tilt region 50t is not specifically limited, and may be, for example, approximately equal to that of the tapered portion 41t of the externally connecting portion 41. This tilt region 50t can be formed by press-injecting a resin while preparing a mold having a desired shape in insert molding.

Although not particularly limited, as illustrated in FIG. 4, in the negative electrode terminal 40, a boundary between the externally connecting portion 41 and the shaft portion 43 preferably has a rounded shape in a cross section taken along the height direction Z of the battery 100. A portion located at the boundary between the externally connecting portion 41 and the shaft portion 43 and having a rounded shape will be hereinafter referred to as a terminal curved portion 40r. The terminal curved portion 40r is a portion of an outer peripheral surface of the negative electrode terminal 40, and is a curved portion continuous with the externally connecting portion 41 and the shaft portion 43. Since the negative electrode terminal 40 includes the terminal curved portion 40r, when the resin is press-injected from a side of the externally connecting portion 41, for example, the resin can more easily flow toward the support portion 44. Accordingly, a gap between the sealing plate 14 and the negative electrode terminal 40 can be suitably filled with the insulating member 50, and thus, safety of the battery 100 is enhanced. This terminal curved portion can be formed by, for example, press work. Although not particularly limited, the terminal curved portion 40r preferably has a curvature radius of R1 or more and R5 or less, for example.

The electrode body connecting portion 42 is located inside the battery case 10, and electrically connected to the electrode body 20. As illustrated in FIG. 4, the electrode body connecting portion 42 has a plate shape, bends at an approximately right angle from a rear end of the support portion 44, and extends downward. The electrode body connecting portion 42 extends toward the bottom wall 12a. The electrode body connecting portion 42 bends forward in an intermediate portion thereof. The electrode body connecting portion 42 extends toward the bottom wall 12a again below a bent portion thereof. With this bending, a front end of the electrode body connecting portion 42 is located in a center portion of the support portion 44 in the short-side direction.

The shaft portion 43 is located between the externally connecting portion 41 and the electrode body connecting portion 42, and is inserted in the terminal mounting hole 19. The shaft portion 43 extends upward from the support portion 44. As illustrated in FIG. 4, the shaft portion 43 is located substantially at a center portion of the support portion 44 in the short-side direction X. A length of the shaft portion 43 in the short-side direction X is shorter than a length of each of the support portion 44 and the terminal mounting hole 19 in the short-side direction X. Although not shown, a length of the shaft portion 43 in the long-side direction Y is shorter than a length of each of the support portion 44 and the terminal mounting hole 19 in the long-side direction Y. Thus, the shaft portion 43 is separated from an inner peripheral surface of the terminal mounting hole 19. A difference in size among the externally connecting portion 41, the shaft portion 43, and the support portion 44, the shaft portion 43 appears to be recessed relative to the externally connecting portion 41 and the support portion 44.

The support portion 44 is located between the electrode body connecting portion 42 and the shaft portion 43. The support portion 44 is a plate-shaped member extending horizontally along the inner surface 14B of the sealing plate 14. As illustrated in FIG. 4, a length of the support portion 44 in the short-side direction X is longer than a length of the terminal mounting hole 19 in the short-side direction X. Although not shown, a length of the support portion 44 in the long-side direction Y is longer than a length of the terminal mounting hole 19 in the long-side direction Y. A dimension of the support portion 44 in a radial direction is larger than that of the terminal mounting hole 19.

A surface of at least a part of a portion of the negative electrode terminal 40 in contact with the insulating member 50 may be subjected to a roughening treatment. The “roughening treatment” herein is a treatment with which unevenness is formed on the surface to thereby increase a surface area and enhance an anchor effect so that bondability and adhesion between the negative electrode terminal 40 and the insulating member 50 are further enhanced. In addition to adjustment of the shape of the externally connecting portion 41, the roughening treatment can more suitably enhance adhesion between the negative electrode terminal 40 and the insulating member 50. The roughening treatment can be performed by, for example, laser irradiation or sand blasting. A portion of the negative electrode terminal 40 subjected to the roughening treatment constitutes a roughening treatment portion 40s. As illustrated in FIG. 4, in this preferred embodiment, the roughening treatment portion 40s is formed on lower surfaces of the shaft portion 43 and the externally connecting portion 41. The roughening treatment portion may be formed on the entire portion with which the negative electrode terminal 40 or the insulating member 50 is in contact.

<Fabrication Method of Battery>

Next, an example of a method for fabricating the battery 100 will be described. A fabrication method disclosed here includes a preparation step (1) and a sealing step (2). In this preferred embodiment, the preparation step (1) includes an insert molding process (1A).

In the preparation step (1), at least the package 12, the sealing plate 14, the positive electrode terminal 30, the negative electrode terminal 40, and the electrode body 20 are prepared. In this preferred embodiment, the externally connecting portions of the positive electrode terminal and the negative electrode terminal 40 are formed to include the bodies and the tapered portions. The tapered portions herein are disposed at two locations at a center side of the battery 100 in the long-side direction Y.

In the insert molding process (1A), the sealing plate 14, the positive electrode terminal 30, the negative electrode terminal 40, and the insulating member 50 are integrated to form an assembly part (e.g., sealing plate assembly 60). The sealing plate assembly 60 can be fabricated by insert-molding the sealing plate 14, the positive electrode terminal 30, the negative electrode terminal 40, and the insulating member 50. Accordingly, the number of parts can be reduced, and a conduction path can be easily formed, as compared to a conventional method using a rivet. Insert molding can be performed according to a known method as described in JP2021-086813A, JP2021-086814A, JP03986368B, or JP6648671B, for example. For example, an insert molding process can be carried out by a method using a molding die including an upper die and a lower die. For example, the insert molding process includes a part setting step, a positioning step, an upper die setting step, an injection molding step, an upper die releasing step, and a part detaching step.

FIG. 8 is a schematic view of a molding die 200. In the part setting step, the sealing plate 14 is mounted to the molding die 200. However, FIG. 8 shows only the lower die 210 in the molding die 200 and does not show the upper die. As illustrated in FIG. 8, the lower die 210 includes a body 212 and two slide members 214. The body 212 supports the sealing plate 14 and positions the sealing plate 14. The body 212 includes a recess (not shown) into which a melted resin flows. In the part setting step, the positive electrode terminal 30 and the negative electrode terminal 40 are respectively inserted in the terminal mounting holes 18 and 19 of the sealing plate 14, and then, the sealing plate 14 is mounted to the body 212 of the lower die 210. The externally connecting portions of the positive electrode terminal 30 and the negative electrode terminal 40 are sized enough to be inserted in the terminal mounting holes 18 and 19 as described above. Thus, in this preferred embodiment, the positive electrode terminal 30 and the negative electrode terminal 40 are inserted into the terminal mounting holes 18 and 19 from the externally connecting portions thereof.

Next, the positioning step is performed. The positioning step is started by performing a predetermined operation such as pressing of a switch after the sealing plate 14, the positive electrode terminal 30, and the negative electrode terminal 40 are mounted to the body 212 of the lower die 210. In the positioning step, the two slide members 214 retracted forward move rearward as indicated by arrows. Accordingly, the positive electrode terminal 30 and the negative electrode terminal 40 are sandwiched between the body 212 and the slide members 214. The positive electrode terminal 30 and the negative electrode terminal 40 are thereby supported by the body 212 and the slide members 214 and positioned. Rear surfaces of the slide members 214 have shapes corresponding to bent shapes of the electrode body connecting portions 42 of the positive electrode terminal 30 and the negative electrode terminal 40. In a case where the electrode body connecting portions of the electrode terminals extend in the height direction without bending, no slide members are necessary, and a lower die having no movable portion is sufficient. The shapes of the electrode terminals are not specifically limited, and for example, the electrode body connecting portions may be flat. At the time when the positioning step is completed, the recess of the lower die 210 is located between each of the terminal mounting holes 18 and 19 of the sealing plate 14 and the support portion 44 of an associated one of the positive electrode terminal 30 and the negative electrode terminal 40.

In the upper die setting step, an unillustrated upper die descends from above such that the sealing plate 14, the positive electrode terminal 30, and the negative electrode terminal 40 are sandwiched between the upper die and the lower die 210 in the height direction Z. The upper die includes a sealing portion to be in contact with the lower die, a recess into which the resin flows, and a gate portion connected to the recess. The gate portion is an inlet through which the melted resin flows into the molding die 200. The gate portion is connected to a resin injection outlet of an injection molding machine. The recess of the upper die faces the recess of the lower die 210 with the sealing plate 14 interposed therebetween.

In the injection molding step, first, the molding die 200 is heated. A heating temperature varies depending on a type of the resin, and is, for example, about 100° C. or more and 200° C. or less. When heating of the molding die 200 is completed, the melted resin is press-injected from the gate portion. The melted resin fills the recess of the upper die and then fills the recess of the lower die 210 through the terminal mounting holes 18 and 19. Thereafter, the molding die 200 and a molded product are cooled. Accordingly, the insulating member 50, the sealing plate 14, the positive electrode terminal 30, and the negative electrode terminal 40 are integrally molded. The resin cooled near the gate portion is the projections 50c described above.

The resin injected in the injection molding step can be a highly viscous resin such as perfluoro-alkoxy fluororesin (PFA) or polyphenylene sulfide (PPS) resin. Thus, even in the case of heating the molding die 200, the resin has low flowability and does not easily fill a desired position. In view of this, the externally connecting portions 41 of the electrode terminals include the tapered portions 41t and/or the round portions 41r as described above. Accordingly, the resin can be suitably caused to flow, and thus, the insulating member 50 can be formed at a desired position, and the battery 100 having higher safety can be fabricated.

In the upper die releasing step, the upper die rises and is separated from the lower die 210. In the part detaching step, the molded product is detached from the lower die 210. After the part detaching step, the step of removing molding burrs may be performed.

In the sealing step (2), the sealing plate assembly 60, the electrode body 20, and the electrolyte prepared as described above are sealed while being housed in the package 12. Specifically, first, the electrode body connecting portion 42 of the sealing plate assembly 60 is connected to the electrode body 20. Next, the electrode body 20 is inserted from the opening 12h of the package 12, and the sealing plate 14 of the sealing plate assembly 60 and a periphery of the opening 12h of the package 12 are joined by, for example, laser welding. Thereafter, the electrolyte is injected from an injection hole, and the injection hole is sealed with a sealing member, thereby hermetically enclosing the battery 100. In this manner, the battery 100 can be fabricated.

<Application of Battery>

The battery 100 can be used for various applications, and suitably used as a power source (drive power source) for a motor mounted on a vehicle such as an automobile or a truck. Although not particularly limited, examples of the type of the vehicle include a plug-in hybrid electric vehicle (PHEV), a hybrid electric vehicle (HEV), and a battery electric vehicle (BEV). Since the battery 100 has enhanced safety, the battery 100 can be suitably used for constructing a battery assembly.

Some preferred embodiments of the present disclosure have been described, but the embodiments are merely examples. The present disclosure can be carried out in other various modes. The present disclosure can be carried out based on the contents disclosed in the description and common general knowledge in the field. The techniques described in claims include various modifications and changes of the above exemplified preferred embodiments. For example, a part of the preferred embodiments described above may be replaced with another preferred embodiment, and another modified embodiment may be added to the preferred embodiments described above. It may also be deleted as appropriate if the technical features of the preferred embodiments are not described as essential.

For example, in the preferred embodiment described above, the externally connecting portion 41 is sized enough to be inserted in the terminal mounting hole 19, and the externally connecting portion 41 is inserted in the terminal mounting hole 19 in the insert molding process. Alternatively, the electrode body connecting portion may be sized enough to be inserted in the terminal mounting hole. Specifically, it is sufficient that at least one of the electrode body connecting portion and the externally connecting portion of the electrode terminal is sized enough to be inserted in the terminal mounting hole.

As described above, specific aspects of the technique disclosed herein include the following items:
Item 1: an electrode body including a positive electrode and a negative electrode; a battery case having an opening and housing the electrode body; a sealing plate having a terminal mounting hole and sealing the opening; an electrode terminal having one end electrically connected to the electrode body inside the battery case and another end inserted in the terminal mounting hole and exposed to outside of the sealing plate; and a resin insulating member insulating an outer surface of the sealing plate from the electrode terminal, the outer surface being a surface of the sealing plate and located at an outer side of the battery case in a state where the opening is sealed. The electrode terminal includes an externally connecting portion located outside the battery case and disposed at the outer surface of the sealing plate, an electrode body connecting portion electrically connected to the electrode body, and a shaft portion located between the externally connecting portion and the electrode body connecting portion and inserted in the terminal mounting hole. The sealing plate has a rectangular shape in a plan view, the externally connecting portion includes a body that is flat and rectangular in the plan view, and a side surface of the body includes a tapered portion having a tapered shape or a round portion located at each end of the side surface and having a curved shape.
Item 2: The battery according to item 1, wherein the sealing plate, the electrode terminal, and the insulating member are insert-molded.
Item 3: The battery according to item 1 or 2, wherein the insulating member includes a body region having a rectangular shape in the plan view, wherein the tapered portion and/or the round part of the externally connecting portion are located at least near the projection of the insulating member in the plan view.
Item 4: The battery according to item 3, wherein the insulating member includes a tilt region that tilts from the body region toward the projection in the plan view.
Item 5: The battery according to any one of items 1 4, wherein the externally connecting portion includes a first side surface extending along a long side of the rectangular sealing plate and a second side surface extending along a short side of the sealing plate in the plan view, and the tapered portion tilts toward the second side surface such that an angle formed by the tapered portion and the first side surface is 100° or more.
Item 6: The battery according to any one of items 1 to 5, wherein in the electrode terminal, a boundary between the externally connecting portion and the shaft portion has a curved shape in a cross section taken along a height direction of the battery.
Item 7: An electrode terminal that is one of a positive electrode terminal and a negative electrode terminal of a battery, the electrode terminal comprising: an externally connecting portion located outside a battery case and disposed at an outer side of a sealing plate sealing an opening of the battery case; an electrode body connecting portion connected to an electrode body including a positive electrode and a negative electrode; and a shaft portion located between the externally connecting portion and the electrode body connecting portion. The externally connecting portion includes a body that is flat and rectangular in a plan view, and a side surface of the body includes a tapered portion having a tapered shape or a round portion located at each end of the side surface and having a curved shape.
Item 8: The electrode terminal according to item 7, wherein the externally connecting portion includes a first side surface and a second side surface whose length is shorter than a length of the first side surface, and the tapered portion tilts toward the second side surface such that an angle formed by the tapered portion and the first side surface is 100° or more.
Item 9: The electrode terminal according to item 7 or 8, wherein a boundary between the externally connecting portion and the shaft portion has a curved shape.

What is claimed is:

1. A battery comprising:
an electrode body including a positive electrode and a negative electrode;
a battery case having an opening and housing the electrode body;
a sealing plate having a terminal mounting hole and sealing the opening;
an electrode terminal having one end electrically connected to the electrode body inside the battery case and another end inserted in the terminal mounting hole and exposed to outside of the sealing plate; and
a resin insulating member insulating an outer surface of the sealing plate from the electrode terminal, the outer surface being a surface of the sealing plate and located at an outer side of the battery case in a state where the opening is sealed, wherein
the electrode terminal includes
an externally connecting portion located outside the battery case and disposed at the outer surface of the sealing plate,
an electrode body connecting portion electrically connected to the electrode body, and
a shaft portion located between the externally connecting portion and the electrode body connecting portion and inserted in the terminal mounting hole,
the sealing plate has a rectangular shape in a plan view,
the externally connecting portion includes a body that is flat and rectangular in the plan view, and
a side surface of the body includes a tapered portion having a tapered shape or a round portion located at each end of the side surface and having a curved shape.

2. The battery according to claim 1, wherein the sealing plate, the electrode terminal, and the insulating member are insert-molded.

3. The battery according to claim 1, wherein
the insulating member includes
a body region having a rectangular shape in the plan view, and
a projection projecting from one side surface of the body region having the rectangular shape, wherein
the tapered portion and/or the round portion of the externally connecting portion are located at least near the projection of the insulating member in the plan view.

4. The battery according to claim 3, wherein the insulating member includes a tilt region that tilts from the body region toward the projection in the plan view.

5. The battery according to claim 1, wherein
the externally connecting portion includes a first side surface extending along a long side of the rectangular sealing plate and a second side surface extending along a short side of the sealing plate in the plan view, wherein
the tapered portion tilts toward the second side surface such that an angle formed by the tapered portion and the first side surface is 100° or more.

6. The battery according to claim 1, wherein in the electrode terminal, a boundary between the externally connecting portion and the shaft portion has a curved shape in a cross section taken along a height direction of the battery.

7. An electrode terminal that is one of a positive electrode terminal and a negative electrode terminal of a battery, the electrode terminal comprising:
an externally connecting portion located outside a battery case and disposed at an outer side of a sealing plate sealing an opening of the battery case;
an electrode body connecting portion connected to an electrode body including a positive electrode and a negative electrode; and
a shaft portion located between the externally connecting portion and the electrode body connecting portion, wherein
the externally connecting portion includes a body that is flat and rectangular in a plan view, and
a side surface of the body includes a tapered portion having a tapered shape or a round portion located at each end of the side surface and having a curved shape.

8. The electrode terminal according to claim 7, wherein
the externally connecting portion includes a first side surface and a second side surface whose length is shorter than a length of the first side surface, and
the tapered portion tilts toward the second side surface such that an angle formed by the tapered portion and the first side surface is 100° or more.

9. The electrode terminal according to claim 7, wherein a boundary between the externally connecting portion and the shaft portion has a curved shape.
